(19) United States
(12) Patent Application Publication
(10) Pub. No.: US 2022/0315426 A1
(43) Pub. Date: Oct. 6, 2022

(54) APPARATUS AND METHOD FOR PURIFYING BNNT AND PURIFIED BNNT

(71) Applicant: KOREA INSTITUTE OF SCIENCE AND TECHNOLOGY, Seoul (KR)

(72) Inventors: Yongho JOO, Jeollabuk-do (KR); Jaehyoung KO, Jeollabuk-do (KR); Se Gyu JANG, Jeollabuk-do (KR); Seokhoon AHN, Jeollabuk-do (KR)

(21) Appl. No.: 17/525,967

(22) Filed: Nov. 15, 2021

(30) Foreign Application Priority Data
Mar. 30, 2021 (KR) 10-2021-0041336

(51) Int. Cl. C01B 21/064; B01D 15/42; B01D 15/16; B01D 15/12

(52) U.S. Cl. CPC C01B 21/0648; B01D 15/426; B01D 15/166; B01D 15/12; C01P 2004/13; C01P 2002/82; C01P 2002/72

(57) ABSTRACT

The present disclosure relates to an apparatus and a method for purifying BNNT and purified BNNT, more specifically to an apparatus and a method for purifying BNNT, which allow separation of pure BNNT from synthesized BNNT wherein various impurities are included with high purification efficiency and separation of BNNT based on length, and purified BNNT. The method for purifying BNNT according to the present disclosure is characterized in that pure BNNT is separated from synthesized BNNT based on length by inputting a mobile phase including synthesized BNNT into a column chromatography device.

### CROSS-REFERENCE TO RELATED APPLICATION

This application claims priority under 35 U.S.C. § 119 the benefit of Korean Patent Application No. 10-2021-0041336, filed on Mar. 30, 2021, the entire contents of which are incorporated herein by reference.

### BACKGROUND

### 1. Field

This invention was made with the support of the ministry of Trade, Industry and Energy under Project No. 1415175124, which was conducted under the research project entitled “Continuous large scale production of high quality boron nitride nanotubes and their application technology development” within the project named “Project for Development of Core Technology in Nano-Fusion Industrial” under the management of the Korea Evaluation Institute of industrial Technology, from Jan. 1, 2021 to Dec. 31, 2021.

The present disclosure relates to an apparatus and a method for purifying BNNT and purified BNNT, more specifically to an apparatus and a method for purifying BNNT, which allow separation of pure BNNT from synthesized BNNT wherein various impurities are included with high purification efficiency and separation of BNNT based on length, and purified BNNT.

### 2. Description of the Related Art

Boron nitride nanotube (BNNT) is a 1-dimensional nanotube particle having regular hexagonal lattices consisting of boron (B) and nitrogen (N). BNNT is a new material which has received a lot of attentions recently owing to very superior electrical, chemical, thermal and mechanical properties such as high insulating property, superior thermal conductivity and thermal stability, high neutron absorption, etc. Based on these properties, BNNT is used in various applications as a material for electronic devices, a filling material for composites, a material for the aerospace industry, etc. However, the full-fledged application of BNNT has been delayed significantly due to the inveterate problem of purity.

Generally, the BNNT synthesized by the industrially useful large-scale synthesis methods inevitably includes a large amount of impurities, which are byproducts produced from the reaction of a precursor used to induce reaction. The composition of the impurities is different depending on the synthesis method. It is known that the BNNT immediately after synthesis is usually a BNNT mixture containing about 25% of boron nitride (BN) and its allotrope and about 25% of amorphous boron (aB). Since the large amount of impurities hinder the physical and chemical properties of BNNT, the necessity for development of an industrially applicable method for synthesizing and purifying BNNT has increased.

Methods for purifying BNNT are largely classified into purification in solid phase and purification in solution phase. As the methods for purification in solid phase, a method of removing impurities included in BNNT as chlorides by passing hot chlorine gas (Cl₂) through the synthesized BNNT (non-patent document 1: Simard et al., Chemistry of Materials, 2020, 32, 3911), a method of selectively decomposing impurities by injecting water vapor to the synthesized BNNT and treating at high temperature (non-patent document 2: Pasquali et al., Chemistry of Materials, 2019, 31, 1520), etc. have been proposed. The purification in solid phase is advantageous in that high-purity BNNT (>80%) can be obtained easily in large quantities but has the problem that the yield is very low due to the decomposition of BNNT at high temperature. In addition, the high cost for selective gas injection and high-temperature reaction has been pointed out as another problem.

As the methods for purification in solution phase, a method of dispersing synthesized BNNT with a surfactant and then extracting the dispersed BNNT through centrifugation (non-patent document 3: Marti et al., Nanoscale Advances, 2019, 1, 1096), a method of dispersing synthesized BNNT in an organic solvent and then removing impurities through continuous filtration accompanied by ultrasonic dispersion (non-patent document 4: Alston et at, Nanoscale Advances, 2019, 1, 1693), etc. have been proposed. However, although the purification in solution solid phase is advantageous in that it is based on a solid phase process which is very economical in industrial aspect, the purification efficiency of BNNT is very low as compared to the purification in solid phase.

### REFERENCES OF THE RELATED ART

### Patent Documents

(Patent document 1) US Patent Publication No. US 2020-0231439 (2020. 07. 23).
(Patent document 2) International Patent Publication No. WO2020-010458 (2020. 01. 16).
(Patent document 3) US Patent Publication No. US 2019-0292052 (2019. 09. 26).

### Non-Patent Documents

(Non-patent document 1) Simard et al., Chemistry of Materials, 2020, 32, 3911.
(Non-patent document 2) Pasquali et al., Chemistry of Materials, 2019, 31, 1520.
(Non-patent document 3) Marti et al., Nanoscale Advances, 2019, 1, 1096.
(Non-patent document 4) Alston et al., Nanoscale Advances, 2019, 1, 1693.
(Non-patent document 5) Topinka et al., Nano Letters, 2009, 9, 1866.
(Non-patent document 6) Simien et al., ACS Nano, 2008, 2, 1879.

### SUMMARY

The present disclosure is directed to providing an apparatus and a method for purifying BNNT, which allow separation of pure BNNT from synthesized BNNT wherein various impurities are included with high purification efficiency and separation of BNNT based on length, and purified BNNT.

The BNNT purified according to the present disclosure is purified from synthesized BNNT using a column chromatography device and has a full width at half maximum (FWHM) of an absorption peak in a range of 1300-1400 cm⁻¹ in the FTIR spectrum of 47 cm⁻¹ or smaller.

In addition, the BNNT purified according to the present disclosure is purified from synthesized BNNT using a column chromatography device and has an FWHM of an absorption peak in a range of 1350-1400 cm⁻¹ in the Raman spectrum of 23 cm⁻¹±1 cm⁻¹.

In addition, the BNNT purified according to the present disclosure is purified from synthesized BNNT using a column chromatography device and has an absorption peak area in a range of 850-900 cm⁻¹ in the Raman spectrum decreased by 99% or more as compared to the synthesized BNNT.

In addition, the BNNT purified according to the present disclosure is purified from synthesized BNNT using a column chromatography device and has a peak area at 2θ=28.0°±0.5° and a peak area at 2θ=26.7°±0.5° in the XRD spectrum decreased by 99% or more respectively as compared to the synthesized BNNT.

The FWHM of the absorption peak, the absorption peak area or the XRD peak area may be calculated using a Lorentzian fitting function.

The absorption peak in a range of 1300-1400 cm⁻¹ in the FTIR spectrum corresponds to the absorption peak of BNNT. And, absorption peak in a range of 1350-1400 cm⁻¹ in the Raman spectrum corresponds to the absorption peak of BNNT or hBN. In addition, the absorption peak area in a range of 850-900 cm⁻¹ in the Raman spectrum corresponds to the absorption peak of B₂O₃. Furthermore, the peak at 2θ=28.0°±0.5° corresponds to the peak of B₂O₃ and the peak at 2θ=26.7° ±0.5° corresponds to the peak of hBN.

In the method for purifying BNNT according to the present disclosure, pure BNNT is separated from synthesized BNNT and is separated based on length by inputting a mobile phase comprising the synthesized BNNT into a column chromatography device.

The synthesized BNNT is a mixture of BNNT and impurities, the pure BNNT passes through a column faster as it has a longer length, and the BNNT with a relatively longer length is located at a lower portion of the column and the BNNT with a relatively shorter length is located at an upper portion of the column at a specific point of time.

The mobile phase is an aqueous solution in which synthesized BNNT and a surfactant are mixed. Specifically, the surfactant is a bile salt-based surfactant. As the bile salt-based surfactant, sodium cholate (SC) or sodium deoxycholate (DOC) may be used.

The column chromatography device is an apparatus wherein a porous stationary phase is filled in a column, and the porous stationary phase is a polymer gel bead or a glass fiber having pores with a size of 1-80 kDa.

An eluent is injected into a column for transportation of the synthesized BNNT after the mobile phase has been inputted, and the eluent is an aqueous solution wherein a bile salt-based surfactant is mixed.

The BNNT with a relatively longer length and the BNNT with a relatively shorter length are discharged sequentially through a lower portion of a column and the impurities included in the synthesized BNNT are discharged before or after the discharge of the BNNT, and it is determined based on the presence of a UV absorption region in a UV chromatogram of the material discharged through the lower portion of the column whether the material is BNNT.

The material is BNNT if a UV absorption region is present in the UV chromatogram.

The mobile phase may be prepared by a process of preparing an aqueous solution wherein a bile salt-based surfactant is mixed, a process of mixing synthesized BNNT in the aqueous solution, a process of uniformly dispersing the synthesized BNNT in the aqueous solution by irradiating ultrasound to the aqueous solution, and a process of extracting a supernatant of the aqueous solution.

The apparatus for purifying BNNT according to the present disclosure includes: a column chromatography device wherein a porous stationary phase is filled in a column; a mobile phase inputting device which inputs a mobile phase including synthesized BNNT to an upper portion of the column; and an eluent supplying device which supplies an eluent to the column to facilitate the transportation of the mobile phase after the mobile phase is inputted, wherein the synthesized BNNT is a mixture of BNNT and impurities, the pure BNNT passes through a column faster as t has a longer length, and the BNNT with a relatively longer length is located at a lower portion of the column and the BNNT with a relatively shorter length is located at an upper portion of the column at a specific point of time.

The apparatus may further include a UV detecting device which generates a UV chromatogram by irradiating UV to a material that has been discharged through the lower portion of the column, and it may be determined based on the presence of a UV absorption region in the UV chromatogram whether the material is BNNT.

The apparatus and the method for purifying BNNT and the purified BNNT according to the present disclosure provide the following advantageous effects.

Through column chromatography, BNNT with a purity of 99% or higher can be extracted and the pure BNNT can be separated based on length.

In addition, since the non-destructive purification method of column chromatography is used rather than the existing BNNT purification method of purification in solid phase or solution phase, the loss of synthesized BNNT can be minimized.

In addition, remarkable improvement in efficiency can be expected as compared to the existing BNNT purification method in terms of purification time since pure BNNT can be separated from synthesized BNNT based on length in very short time of around 1 hour.

### BRIEF DESCRIPTION OF THE DRAWINGS

FIG. 1 and FIG. 2 schematically illustrate a method for purifying BNNT using column chromatography according to the present disclosure.

FIG. 3 shows the configuration of an apparatus for purifying BNNT according to an exemplary embodiment of the present disclosure.

FIG. 4A shows synthesized BNNT dispersed in solutions containing different surfactants.

FIG. 4B and FIG. 4C show a result of measuring the UV absorbance of BNNT dispersed in aqueous solutions containing different surfactants.

FIG. 4D and FIG. 4E show the SEM and AFM analysis results of synthesized BNNT dispersed in SC.

FIG. 5 shows the UV absorption experiment result for different eluates (f1-f8).

FIGS. 6A-6D show the SEM images of different eluates (f1-f8).

FIGS. 7A-7C show the length distribution of different eluates (f1-f8).

FIGS. 8A-8F show the SEM and TEM analysis results of synthesized BNNT and f3-f5.

FIG. 9A and FIG. 9B show the XRD analysis result for synthesized BNNT and f3-f5.

FIGS. 10A-10C show the Raman spectrum analysis result for synthesized BNNT and f3-f5.

FIGS. 11A-11C show the FTIR spectrum analysis result for synthesized BNNT and f3-f5.

### DETAILED DESCRIPTION

The present disclosure discloses a method for purifying BNNT with remarkably improved purification efficiency, which allows separation and purification of BNNT depending on length.

As mentioned above in the ‘Background’ section, purification in solid phase and purification in solution phase are used as the method for purifying BNNT, but they require high purification cost or show decreased purification efficiency.

The present disclosure presents a method for purifying BNNT with remarkably improved purification efficiency and separating pure BNNT depending on length using a column chromatography process.

Column chromatography is a chromatography method of separating substances based on surface characteristics and size. The principle of column chromatography is as follows.

After filling a porous stationary phase having pores in a column, if a mobile phase including substances to be separated is inputted into the column, difference in the retention time of the substances to be separated in the column occurs due to the interaction with the stationary phase depending on the surface characteristics of the substances to be separated such as hydrophilicity, hydrophobicity, etc. As a result, the substances to be separated can be separated depending on their properties. As an example of the column chromatography techniques, size exclusion chromatography is characterized in that substances to be separated are separated based on their intrinsic physical properties such as size, etc. by preventing interaction between the stationary phase and the substances to be separated. For example, whereas a substance to be separated with a small size enters the pores of the porous stationary phase, a substance to be separated with a large size cannot enter the pores of the porous stationary phase but is discharged through the gaps between the porous stationary phase. Through this process, the substances to be separated can be separated based on size.

Column chromatography is used as a tool of material analysis in various fields. As representative examples, it is widely used for separation of polymer chemical species such as proteins; etc. Column chromatography has been also used for separation of pure CNTs (carbon nanotubes), which have physical properties similar to those of BNNTs, based on diameter, length, number of walls and chiral angle (see non-patent documents 5 and 6).

In the present disclosure, column chromatography is used for purification of synthesized BNNT and separation of BNNT based on length. As described above, whereas the column chromatography has been used to separate specific substances to be separated or to separate pure substances to be separated based on their physical properties, the present disclosure uses column chromatography for purification of synthesized BNNT and separation of pure BNNT based on length. That is to say, the present disclosure is characterized in that purification of synthesized BNNT and separation of pure BNNT based on length are possible through column chromatography at the same time.

The reason why column chromatography is suitable for purification of synthesized BNNT and separation of pure BNNT based on length is because the substances included in synthesized BNNT can be separated effectively by column chromatography. As mentioned above, synthesized BNNT is a mixture including impurities such as boron nitride (BN), amorphous boron (aB), etc. in addition to BNNT. Whereas BNNT has a long linear shape, boron nitride (BN) has a 2-dimensional sheet structure and impurities such as amorphous boron (aB), etc. form a 3-dimensional cluster by aggregating with each other. In addition; whereas BNNT has a nanosized diameter; impurities such as boron nitride (BN), amorphous boron (aB), etc. have micrometer-scale sizes. Also, in terms of chemical properties, BNNT having unique curvature can be easily separated by column chromatography because it has different chemical properties from boron nitride (BN) having a planar structure, and can also be easily separated from amorphous boron (aB) due to difference in chemical properties.

As such, since the BNNT and other impurities included in the synthesized BNNT are dearly distinguished in geometric structure, size and chemical properties, the BNNT and other impurities can be easily separated by column chromatography. In addition, after BNNT has been separated from other impurities, pure BNNT can be separated based on length by utilizing the characteristics of column chromatography.

Although the material characteristics of the synthesized BNNT are major factors in the purification of the synthesized BNNT and separation of BNNT based on length by column chromatography as described above, the following conditions should be satisfied for effective purification of the synthesized BNNT and separation of BNNT based on length.

First, the synthesized BNNT should be dispersed uniformly in a mobile phase. The synthesized BNNT is mixed with the mobile phase and inputted in a column filled with a porous stationary phase in the form of a solution. If the synthesized BNNT is not dispersed uniformly in the mobile phase, the purification of synthesized BNNT and separation of BNNT based on length by column chromatography do not proceed effectively.

Therefore, the present disclosure provides an optimum mobile phase material that can uniformly disperse the synthesized BNNT in a mobile phase. Specifically, in the present disclosure, a bile salt-based surfactant is included in the mobile phase so as to uniformly disperse the synthesized BNNT. The bile salt-based surfactant is effective for uniformly dispersing the synthesized BNNT since it tends to form a 2-dimensional sheet structure. In contrast, the existing linear ionic/non-ionic surfactant is not suitable for uniformly dispersing the synthesized BNNT. This will be confirmed later through experiments. As the bile salt-based surfactant, sodium cholate (SC) or sodium deoxycholate (DOC) may be used, although not being limited thereto.

Second, the optimum porous stationary phase should be used.

As described above, column chromatography is based on the principle that a substance with a relatively smaller size enters the pores of the porous stationary phase whereas a substance with a relatively larger size is passed through the gaps between the porous stationary phase. Therefore, for purification of BNNT from impurities and separation of BNNT based on length, an optimized porous stationary phase should be used.

Specifically, as the porous stationary phase optimized for purification of synthesized BNNT and separation of BNNT based on length, one or more of a polymer gel bead, a polymer and an inorganic porous material having pores with a size of 1-80 kDa may be used. As demonstrated in experimental examples described below, very high purification efficiency of 99% or higher was achieved when Sephacryl® S-200 (Sigma-Aldrich) having pores with a size of 1-80 kDa was used. In purification of pure BNNT from synthesized BNNT and separation of BNNT based on length, it is very important for the porous stationary phase used in the method for purifying BNNT of the present disclosure to satisfy the above-described pore size characteristics. When a polymer gel bead is used, both hydrophilic and hydrophobic gel beads may be used. As the polymer gel bead, any of commercially available Sephacryl® S-100, S-200, S-300, S-400 and S-500 may be used. The polymer may be any of an agarose-based polymer and a Sepharose-based polymer including Sepharose 2B. And, the inorganic porous material may be silica gel or a glass fiber.

As described above, the present disclosure is characterized by purification of BNNT and separation of BNNT based on length using column chromatography. Various column chromatography techniques may be applied depending on focus is placed on purification of BNNT or separation of BNNT based on length. For example, size exclusion chromatography may be applied for effective purification of BNNT or separation of BNNT based on length.

Hereinafter, an apparatus and a method for purifying BNNT and purified BNNT according to an exemplary embodiment of the present disclosure will be described in detail referring to the attached drawings. First, a method for purifying BNNT will be described.

A mobile phase and a stationary phase are prepared respectively for conducting a column chromatography process. The mobile phase is a solution including synthesized BNNT and the stationary phase is a porous stationary phase filled in a column.

The mobile phase is prepared as follows.

First, an aqueous solution wherein a bile salt-based surfactant is mixed is prepared and synthesized BNNT is mixed in the aqueous solution. Then, the synthesized BNNT is uniformly dispersed in the aqueous solution by irradiating ultrasound to the aqueous solution. Then, the preparation of the mobile phase is completed by extracting a supernatant from the aqueous solution through centrifugation.

As the bile salt-based surfactant, sodium cholate (SC) or sodium deoxycholate (DOC) may be used, although not being limited thereto. The synthesized BNNT may be one synthesized through various synthesis methods and may be a mixture of pure BNNT and impurities such as boron nitride (BN), amorphous boron (aB), etc. The dispersion of the synthesized BNNT in the aqueous solution may also be induced stirring, etc., in addition to the ultrasound irradiation, and a 50-80% supernatant of the aqueous solution may be extracted through centrifugation.

The stationary phase is prepared as follows.

After mixing a porous stationary phase in a colloid solution, the colloid solution is filled in a column with a shape of a hollow cylinder. Then, the colloid solution is discharged so that only the porous stationary phase is filled in the column. As the porous stationary phase, a polymer gel bead or a glass fiber having pores with a size of 1-80 kDa may be used.

After the mobile phase and the stationary phase are prepared as described above, the mobile phase is inputted to an upper portion of the column filled with the stationary phase. Then, an eluent which facilitates the transportation of the mobile phase is inputted continuously to the upper portion of the column. As the eluent, an aqueous solution wherein a bile salt-based surfactant is mixed may be used.

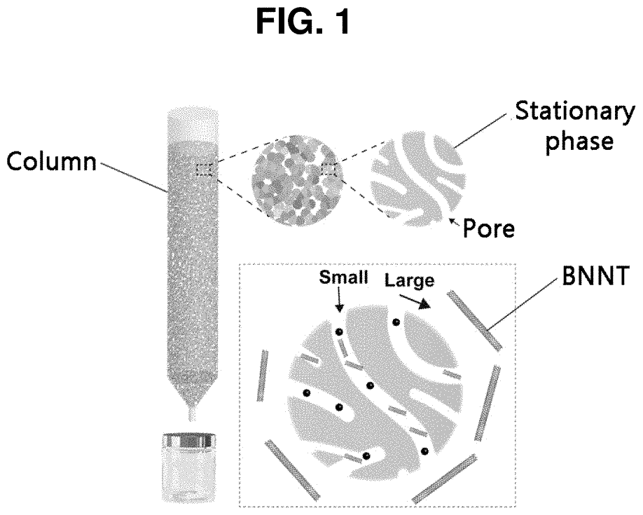

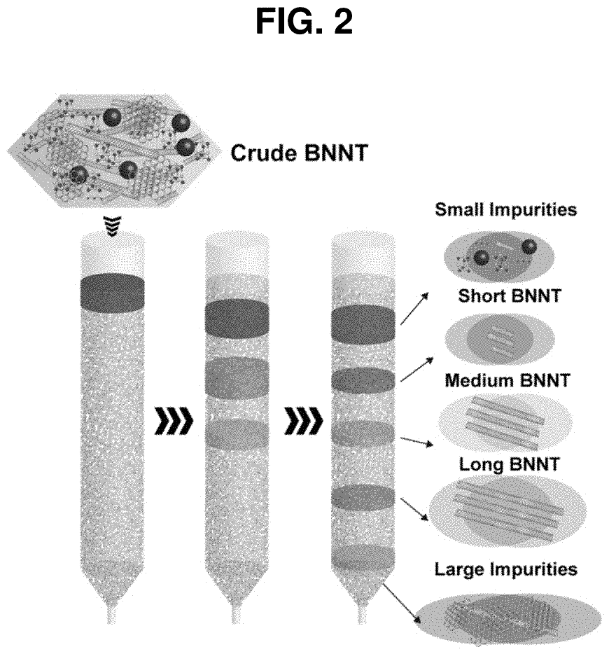

As the mobile phase is inputted and the eluent is injected continuously, the synthesized BNNT included in the mobile phase is transported to the lower portion of the column, and separation of pure BNNT and separation of BNNT based on length occur during this process. Specifically, impurities such as boron nitride (BN), amorphous boron (aB), etc. having micrometer-scale sizes are entrapped in the pores of the porous stationary phase while linear BNNT, although having a nanosized diameter, is transported to the lower portion of the column through the gaps between the porous stationary phase without being entrapped in the pores of the porous stationary phase (see FIG. 1 and FIG. 2).

BNNT and other impurities are separated basically based on this principle. While the BNNT and other impurities are separated, separation of BNNT based on length occurs at the same time. Since the pure BNNT has various lengths, BNNT with a relatively shorter length may be entrapped in the pores of the porous stationary phase based on the same principle as BNNT and other impurities are separated. Accordingly, BNNT with a relatively shorter length is located in the upper portion of the column and BNNT with a relatively longer length is located in the lower portion of the column.

Referring to FIG. 2, during the process of separation of BNNT and other impurities and separation of BNNT based on length described above, impurities with a small size (small impurities) are located in the uppermost portion of the column, the BNNT with a relatively shorter length (short BNNT) and the BNNT with a relatively longer length (medium BNNT, long BNNT) are located therebelow, and impurities with a larger size than the BNNT with a relatively longer length (large impurities) are located in the lowermost portion of the column.

The above description of the location of the BNNT and other impurities along the vertical direction of the column is based on the location at a specific point of time. As time goes by, all the components of the synthesized BNNT inputted in the column are discharged through the lower portion of the column. The impurities with a larger size than the BNNT with a relatively longer length (large impurities) are discharged first through the lower portion of the column, followed by the long BNNT, the medium BNNT, the short BNNT and the small impurities.

Through this process, pure BNNT can be separated from synthesized BNNT and the pure BNNT can be separated depending on length.

It may be determined whether the substance discharged through the lower portion of the column with the lapse of time is BNNT through continuous monitoring. Specifically, a UV chromatogram may be obtained for the substance discharged with the lapse of time using a UV detecting device and it may be determined whether the substance is BNNT based on the UV chromatogram. This is based on the UV absorption characteristics of BNNT. The presence of a UV absorption region in the UV chromatogram indicates that the corresponding substance is BNNT.

Although the accurate analysis of the substance discharged through the lower portion of the column is possible with scanning electron microscopy (SEM), atomic force microscopy (AFM), etc., it may be determined more easily and conveniently whether the corresponding substance is BNNT based on the UV absorption characteristics of the BNNT.

The method for purifying BNNT according to an exemplary embodiment of the present disclosure has been described above. Next, an apparatus for purifying BNNT according to an exemplary embodiment of the present disclosure will be described.

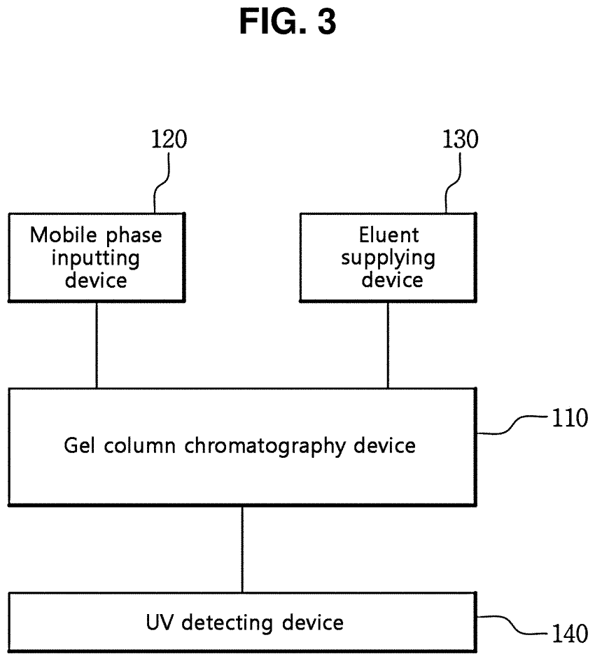

Referring to FIG. 3, the apparatus for purifying BNNT according to an exemplary embodiment of the present disclosure includes a column chromatography device 110, a mobile phase inputting device 120, an eluent supplying device 130 and a UV detecting device 140.

The column chromatography device 110 is a cylindrical column in which a porous stationary phase is filled. Specifically, the porous stationary phase may be any of a polymer gel bead, a polymer and an inorganic porous material having pores with a size of 1-80 kDa.

The mobile phase inputting device 120 is a device which inputs a mobile phase including synthesized BNNT into the upper portion of the column, and the mobile phase including synthesized BNNT is an aqueous solution wherein synthesized BNNT is uniformly dispersed in a bile salt-based surfactant. As the bile salt-based surfactant, sodium cholate (SC) or sodium deoxycholate (DOC) may be used.

The eluent supplying device 130 is a device which supplies an eluent for facilitating the transportation of the mobile phase inputted in the column to the column. A predetermined amount of eluent may be supplied continuously to the column while separation of pure BNNT from the mobile phase and separation of BNNT based on length are proceeded. The eluent may be an aqueous solution in which a bile salt-based surfactant is mixed.

If the mobile phase is inputted into the column chromatography device and the eluent is supplied, separation of pure BNNT from the mobile phase and separation of BNNT based on length are proceeded. The separation of pure BNNT from the mobile phase and separation of BNNT based on length are the same as described above in the description of the method for purifying BNNT according to an exemplary embodiment of the present disclosure.

To summarize briefly, if the mobile phase is inputted and the eluent is supplied continuously, impurities having micrometer-scale sizes such as boron nitride (BN), amorphous boron (aB), etc. are entrapped in the pores of the porous stationary phase, while linear BNNT, although having a nanosized diameter, is transported to the lower portion of the column through the gaps between the porous stationary phase without being entrapped in the pores of the porous stationary phase. Based on this principle, separation of BNNT from other impurities and separation of BNNT based on length are proceeded at the same time.

As separation of BNNT from synthesized BNNT and separation of BNNT based on length are proceeded, large impurities, long BNNT, medium BNNT, short BNNT and small impurities are discharged sequentially with time through the lower portion of the column.

The UV detecting device 140 generates a UV chromatogram by irradiating UV to the substance that has been discharged through the lower portion of the column. Since BNNT has UV absorption characteristics, a UV absorption region is present in the UV chromatogram of BNNT. Accordingly, after generating a UV chromatogram by irradiating UV to the substance that has been discharged through the lower portion of the column using the UV detecting device, it may be determined whether the UV-irradiated substance is BNNT depending on the presence of a UV absorption region in the UV chromatogram.

The apparatus and method for purifying BNNT and purified BNNT thereby according to an exemplary embodiment of the present disclosure have been described above. Hereinafter, the present disclosure will be described more specifically through experimental examples.

### Experimental Example 1: Preparation of Synthesized BNNT

BNNT was synthesized by loading amorphous boron in a heating furnace and converting the amorphous boron to boron oxide by heating at 650° C. for 6 hours.

### Experimental Example 2: Dispersion Characteristics of Synthesized BNNT Depending on Surfactant

After preparing 0.02 wt % aqueous solutions of bile salt-based surfactants SC (sodium cholate) and DOC (sodium deoxycholate) and linear ionic surfactants SDS (sodium dodecyl sulfate), CTAS (cetyltrimethylammonium bromide) and SOBS (sodium dodecylbenzene sulfonate), respectively, 0.2 mg/mL of the synthesized BNNT was added to each aqueous solution. Then, ultrasound was irradiated to each aqueous solution for 5 minutes. The synthesized BNNT had been synthesized according to Experimental Example 1.

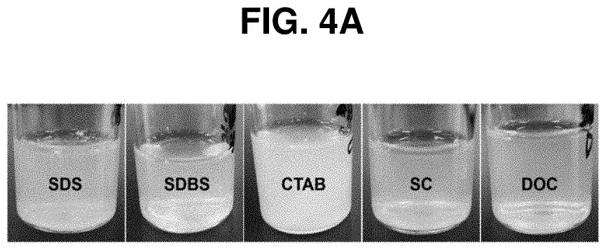

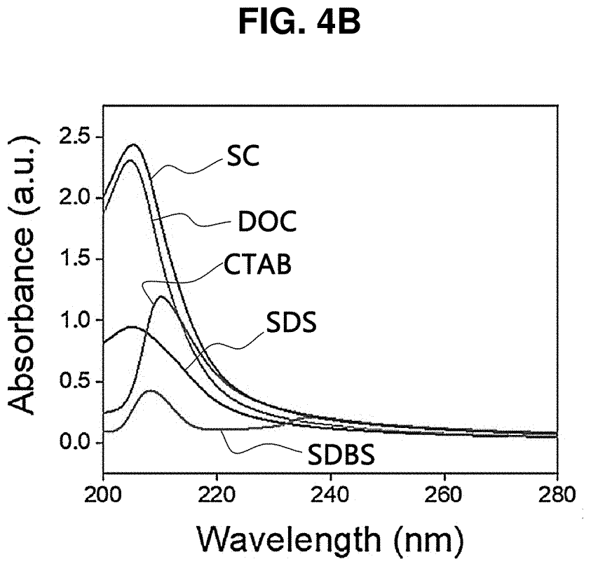

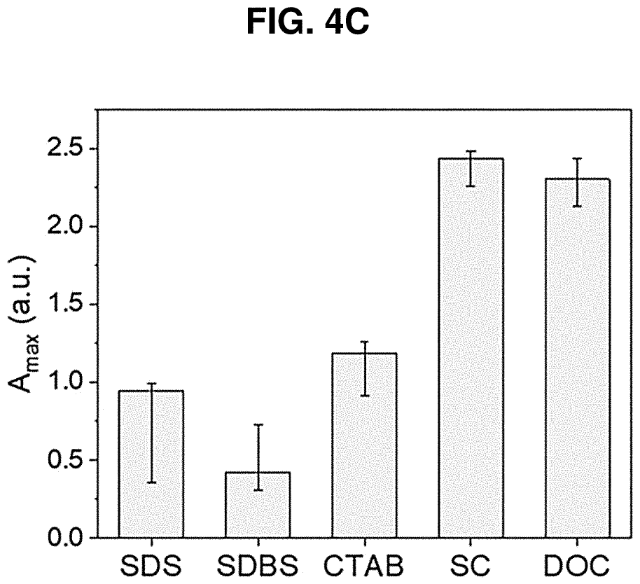

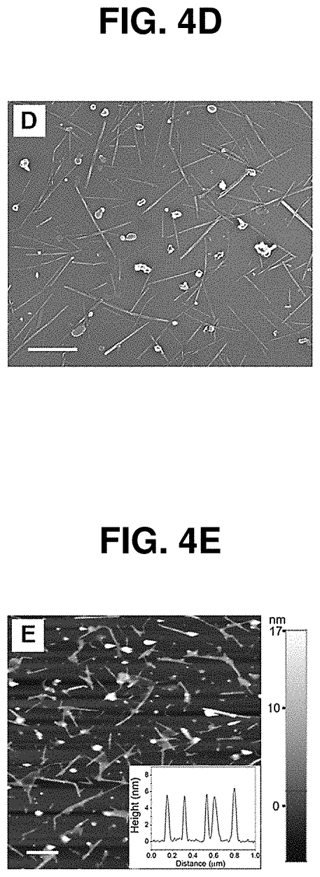

The dispersion state of the synthesized BNNT in each surfactant is shown in FIG. 4A. Referring to FIG. 4A, it can be seen that extensive aggregation occurred when the anionic surfactants SDS and SDBS were used. Also, when the cationic surfactant CTAB was used, the solution was very turbid and large aggregates were floating. In contrast, when the bile salt-based surfactants SC and DOC were used, the synthesized BNNT was uniformly dispersed with no aggregate and low turbidity.

The dispersion state shown in FIG. 4A could also be confirmed quantitatively. Since pure BNNT exhibits UV absorption characteristics, UV was irradiated to each aqueous solution and dispersion state was investigated quantitatively through absorption characteristics. After extracting a supernatant of each aqueous solution through centrifugation, UV was irradiated to each extracted supernatant. The UV absorbance measurement result for the supernatants is shown in FIG. 4B and FIG. 4C. Referring to FIG. 4B and FIG. 4C, it can be seen that, whereas the UV absorbance was very low when the linear ionic surfactants SDS, SDBS and CTAB were used, distinct UV absorption characteristics were exhibited when the bile salt-based surfactants SC and DOC were used. These UV absorption characteristics are consistent with the observation result of the dispersion state of FIG. 4A.

The SEM (see FIG. 4D) and AFM (see FIG. 4E) images of the synthesized BNNT dispersed in SC and DOC, respectively, show that pure BNNT with a size of 5 nm or smaller is dispersed uniformly.

### Experimental Example 3: Separation of Synthesized BNNT Through Column Chromatography and Analysis of Eluate

After mixing a gel bead in a 20% ethanol aqueous solution, the mixture was inputted in a column using a 10-mL syringe. Then, the gel bead was filled in the column by discharging the solvent component excluding the gel bead out of the column. Then, the column was equilibrated by injecting a 1 wt % SC aqueous solution.

2 mL of the SC aqueous solution with the synthesized BNNT prepared according to Experimental Example 1 dispersed was inputted into the column. Then, a 1 wt % SC aqueous solution above the critical micelle concentration was supplied as an eluent. Then, the eluate discharged from the column was collected with 0.5-mL intervals. The eluate collected with 0.5-mL intervals was named fractions 1-8 (f1-f8), f1 being the first discharged eluate and f8 being the last discharged eluate.

UV absorption experiment and SEM analysis were conducted for each eluate (f1-f8).

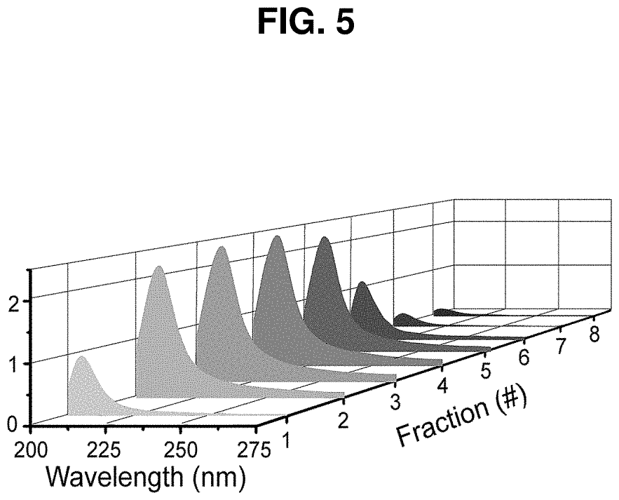

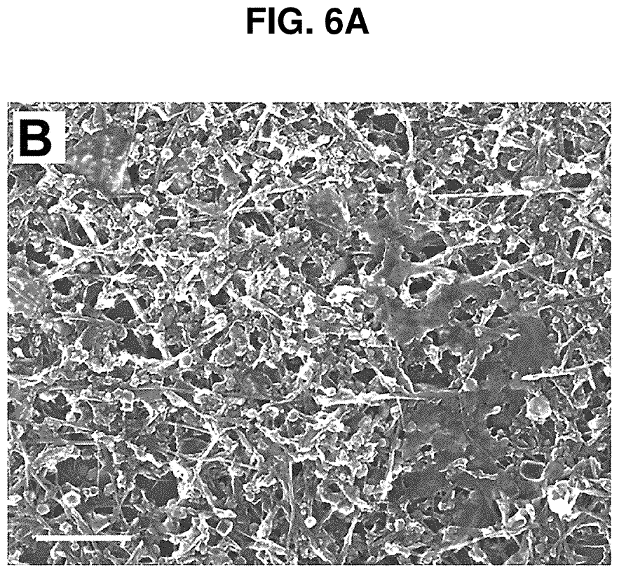

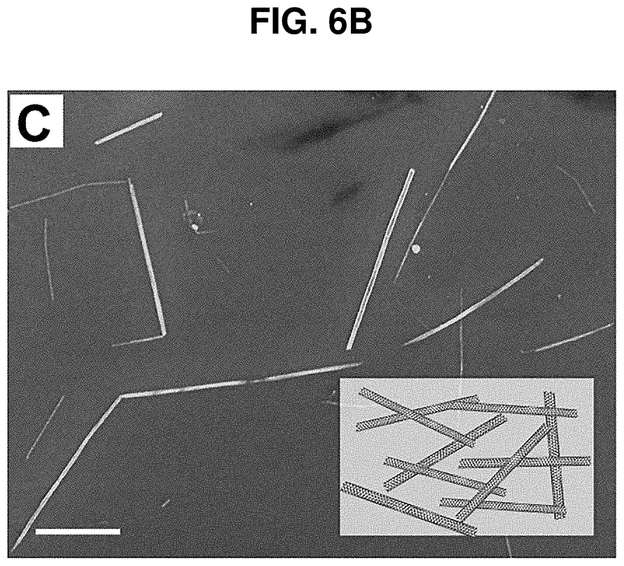

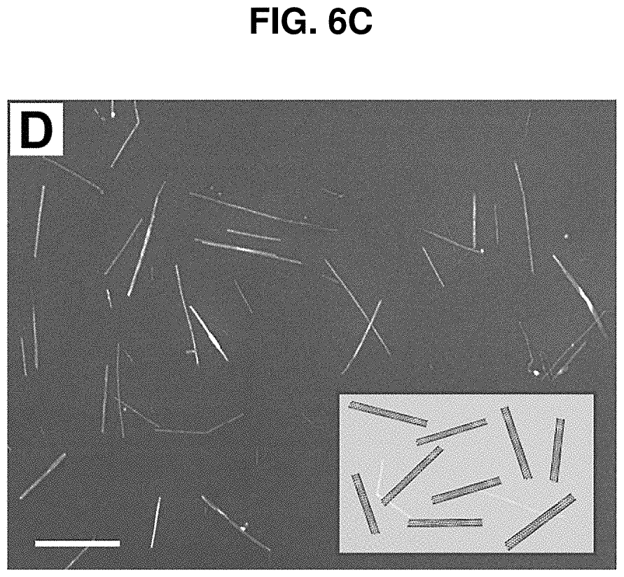

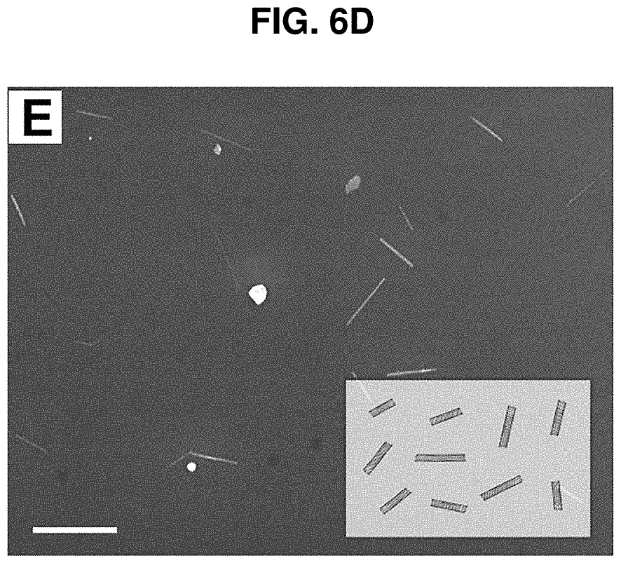

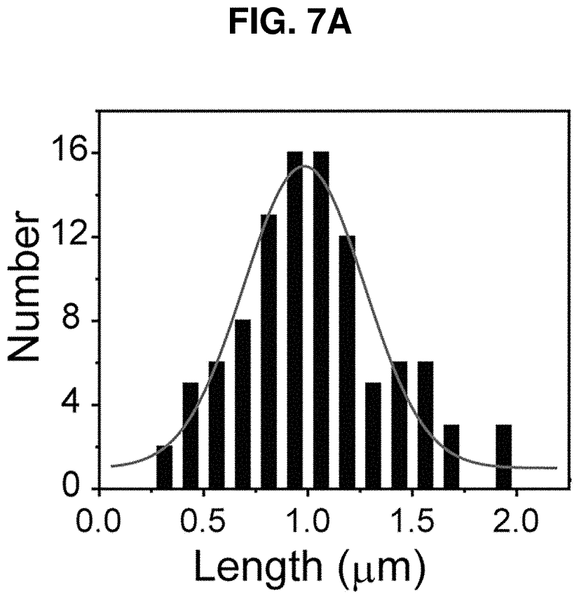

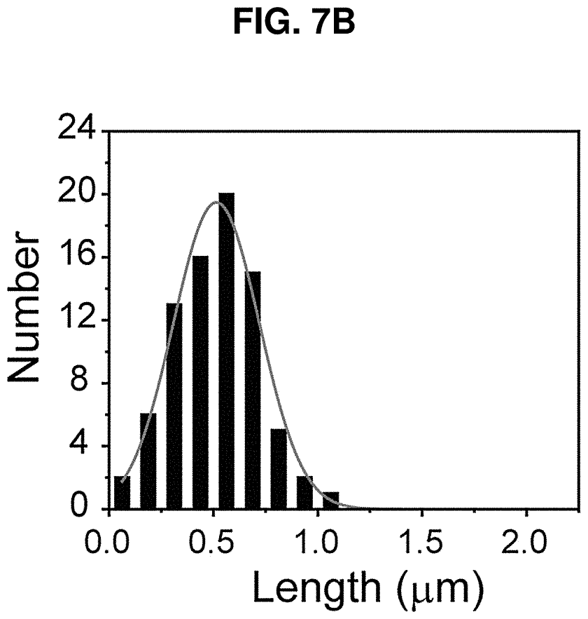

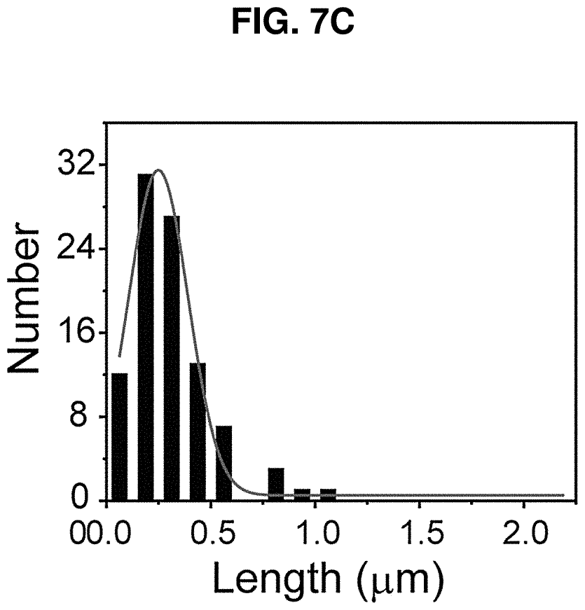

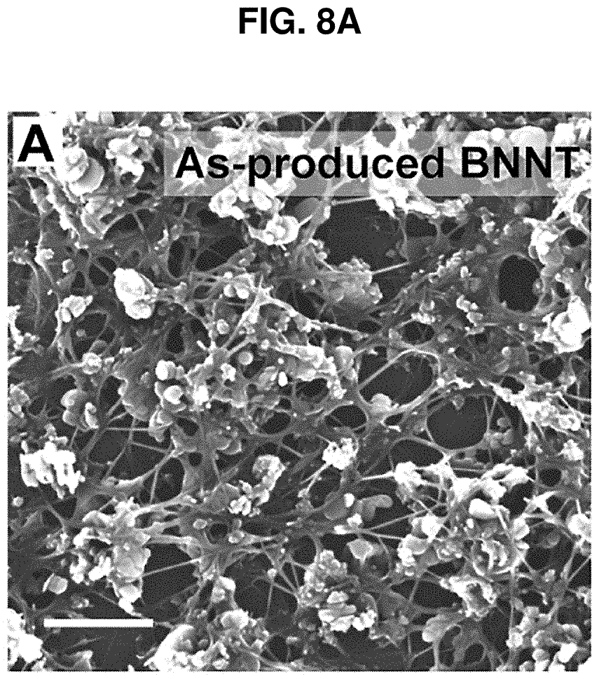

FIG. 5 shows the UV absorption experiment for each eluate (f148), FIGS. 6A-6D show the SEM images of the eluates (f148), and FIGS. 7A-7C show a result of calculating the length distribution of each eluate (f1-f8).

As shown in FIG. 5, among the eluates (f1-f8), f2-f5 showed distinct UV absorption regions whereas f1 and f6 showed relatively smaller UV absorption regions and f7 and f8 showed almost no UV absorption characteristics.

The SEM images of the eluates (f1-f8) show that f1 and f7-f8 (see FIG. 6A) consist mostly of impurities, whereas BNNT with a long length (1.00±0.36 μm) is individualized in f2 (see FIG. 6B). In addition, BNNT with a medium length (0.51±0.21 μm) can be observed in f3-f5 (see FIG. 6C) and BNNT with a short length (0.31±0.19 μm) can be observed in f6 (see FIG. 6D). Furthermore, impurities other than BNNT were hardly seen in f2-f6, but impurities such as boron nitride, amorphous boron, etc. were concentrated in f7-f8 and were included partly in f1.

From the SEM images of the eluates (f1-f8), it was confirmed that pure BNNT was purified from the synthesized BNNT and the pure BNNT was separated based on length.

As a result of calculating the length distribution of f2, f4 and f6 the BNNT of f2 (see FIG. 7A) had an average length of 1.00±0.36 μm, with N=106. The BNNT of f4 (see FIG. 7B) had an average length of 0.51±0.21 μm, with N=80. The BNNT of f6 (see FIG. 7C) had an average length of 0.31±0.19 μm, with N=95.

In order to evaluate the BNNT purification efficiency of column chromatography conducted in Experimental Example 3, SEM and TEM analyses were conducted on the eluates f3-f5, and the result was compared with the SEM and TEM analysis results for synthesized BNNT.

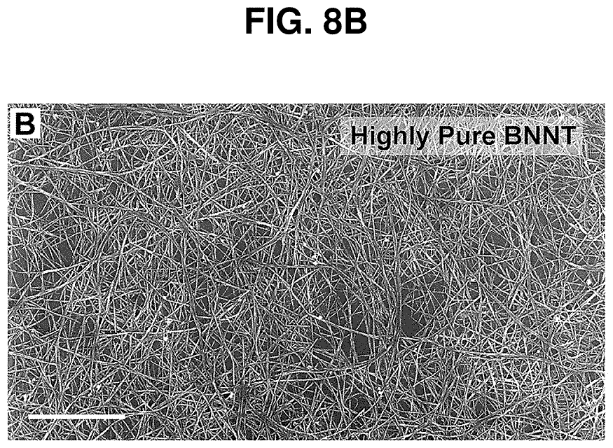

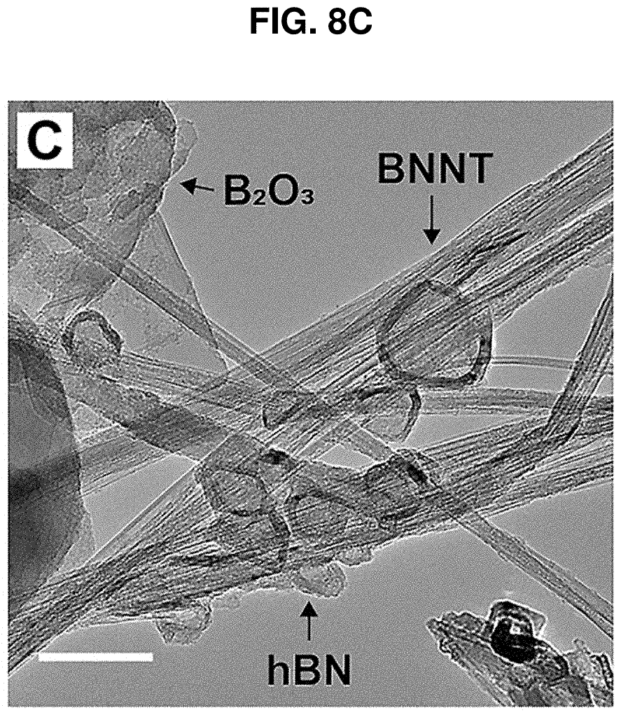

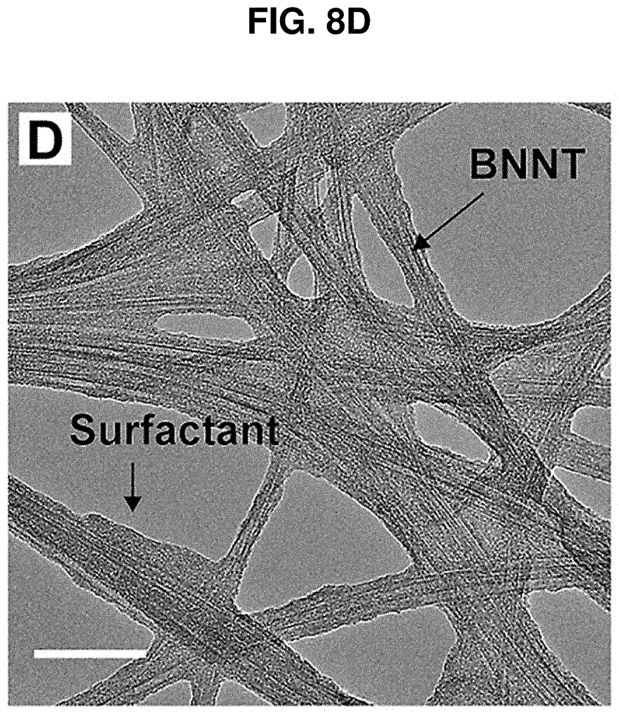

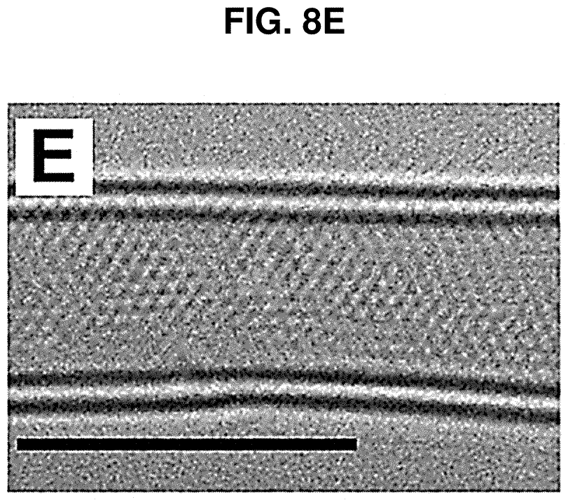

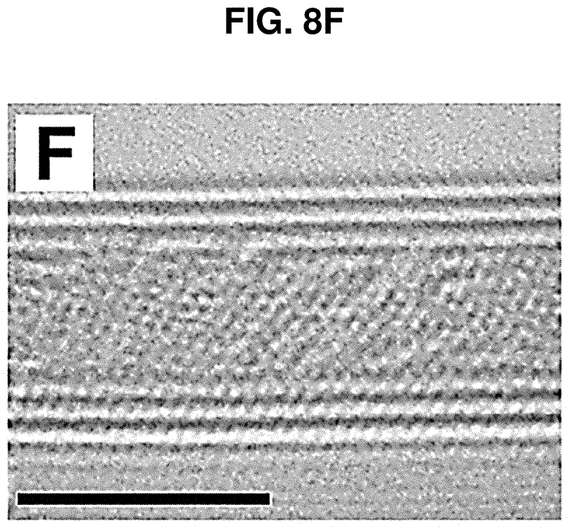

FIG. 8A and FIG. 8C show the SEM and TEM analysis results for synthesized BNNT, and FIG. 8B and FIG. 8D show the SEM and TEM analysis results for f3-f5. As shown in FIG. 8A and FIG. 8C, a considerable amount of impurities was included in the synthesized BNNT, and the impurities were mostly hBN and B₂O₃. In contrast, referring to FIG. 8B and FIG. 8D, BNNT was present with high purity throughout the whole region analyzed by SEM, and the TEM analysis result revealed that small spherical impurities known as BN cages were removed almost completely.

In addition, referring to FIG. 8E and FIG. 8F, very small amorphous particles of 5 nm or smaller adhering to the wall were observed. They were derived from residual SC or amorphous BN and were removed by electron beam during the SEM and TEM analyses.

From the SEM and TEM analyses described above, it was confirmed that high-purity BNNT was purified from the synthesized BNNT through column chromatography.

The effect of purification was investigated further through XRD, infrared spectroscopy and Raman spectroscopy.

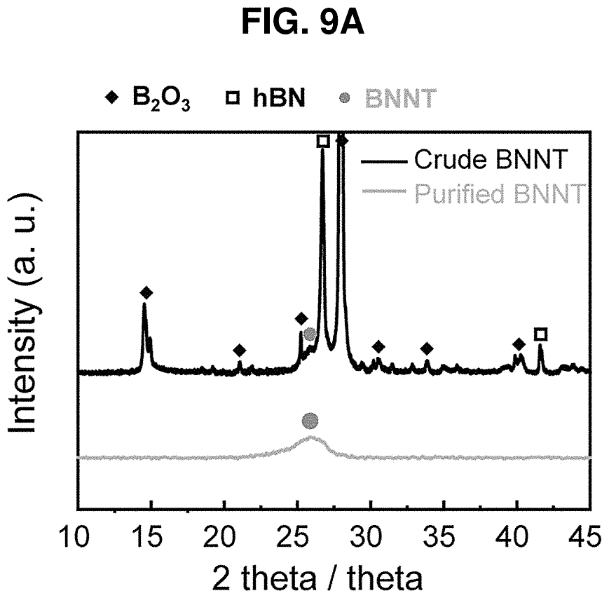

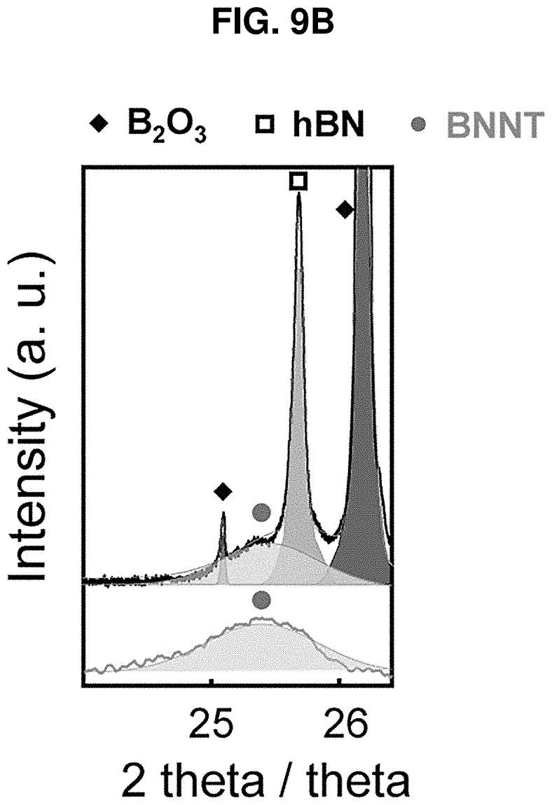

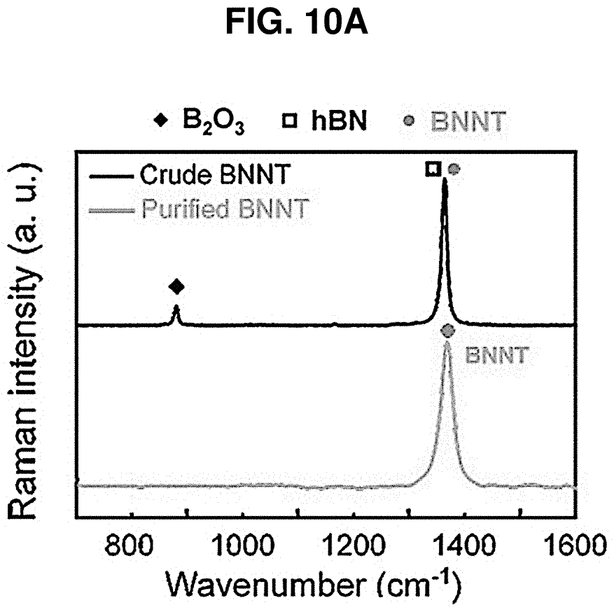

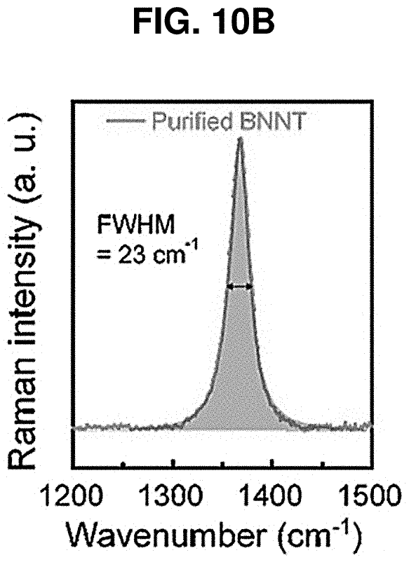

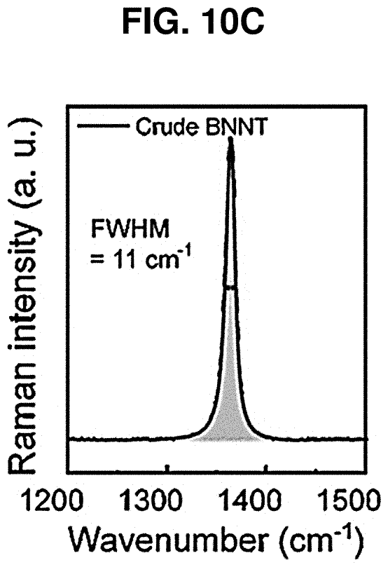

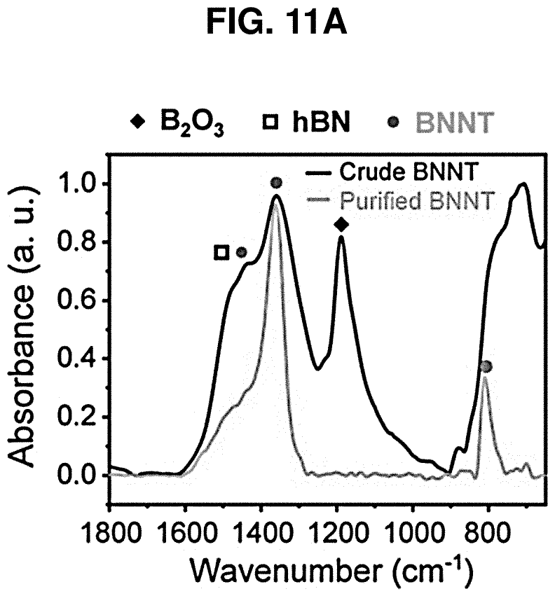

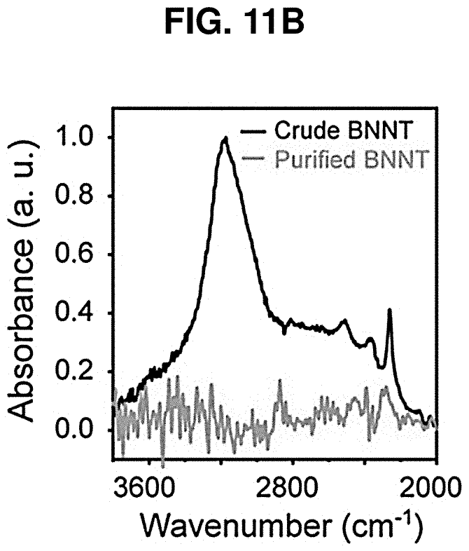

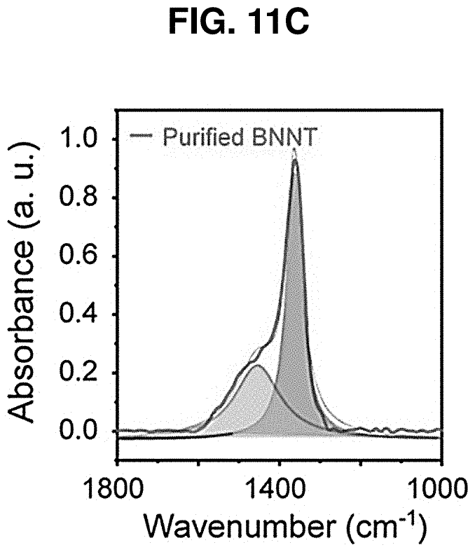

FIG. 9A and FIG. 9B show the XRD analysis results for synthesized BNNT and f3-f5, FIGS. 10A-10C show the Raman spectrum analysis results for synthesized BNNT and f3-f5, and FIGS. 11A-11C show the FTIR spectrum analysis results for synthesized BNNT and f3-f5.

Referring to FIG. 9A and FIG. 9B, it can be seen that strong absorption occurred at 2θ=26.7° and 2θ=28.0°, which correspond to the characteristic X-ray absorption region of impurities present in the synthesized BNNT. They correspond to respectively to hBN and B₂O₃. Therefore, it was confirmed that the materials are present in large quantities in the synthesized BNNT. In contrast, for f3-f5, strong absorption was observed at 28=25.8° corresponding to the X-ray absorption region of highly purified BNNT. The absence of the absorption peaks corresponding to hBN and B₂O₃ confirms the high purity of BNNT in f3-f5. The substantial purity and purification efficiency of BNNT before and after purification can be determined by comparing the area of individual absorption peaks occurring in the X-ray diffraction spectrum. For accurate area calculation, the Lorentzian fitting function was applied to the individual absorption peaks. However, the distinction between individual absorption peaks is not easy for the synthesized BNNT or f3-f5 of the present disclosure because the X-ray absorption regions are very close. Accordingly, deconvolution was conducted for the X-ray absorption region obtained by applying multiple Lorentzian fitting. Through the comparison of the area of the individual absorption peaks, the purification efficiency was calculated as 99.8% for hBN and 99% or higher for B₂O₃. For reference, the Lorentzian fitting function was used in the present disclosure to convert the absorption peak in the form of a 2-dimensional function for quantification of the absorption peak.

Referring to FIGS. 10A-10C, it can be seen that very strong Raman absorption occurred at 880 cm⁻¹ and 1366 cm⁻¹ in the Raman spectrum of the synthesized BNNT. They correspond to the Raman frequencies of B₂O₃ and hBN, respectively, and support the result of X-ray diffraction experiment confirming the presence of a large quantity of impurities in the BNNT mixture. The absence of Raman absorption at 880 cm⁻¹ for f3-f5 after purification suggests that B₂O₃ was removed effectively. Unlike the X-ray diffraction experiment, it is difficult to calculate the accurate purity of BNNT by Raman spectroscopy because hBN and BNNT have nearly the same Raman frequencies. Accordingly, in the present disclosure, the full width at half maximum (FWHM) of each absorption peak was used for comparison of purity rather than the Raman frequency. In general, hBN is known to exhibit very strong absorption at 1366 cm⁻¹ in the Raman region, where the full width at half maximum is 8-12 cm⁻¹. In contrast, BNNT is known to exhibit relatively lower absorption in the similar Raman region as compared to hBN, where the full width at half maximum is 16-30 cm⁻¹. As a result of Lorentzian fitting for the synthesized BNNT and f3-f5 at 1366 cm⁻¹, the full width at half maximum of the synthesized BNNT was calculated as 11 cm⁻¹ and the full width at half maximum of f3-f5 was calculated as 23 cm⁻¹. This suggests that the f3-f5 obtained from the purification consists mostly of pure BNNT. This provides pseudo-quantitative evidence for the effective improvement of purity by the purification of the present disclosure.

Referring to FIGS. 11A-11C, a wide absorption distribution can be confirmed at about 1400 cm⁻¹ and 750 cm⁻¹ from the FTIR spectrum of the synthesized BNNT, which suggests the presence of hBN. In contrast, f3-f5 exhibits very limited absorption distribution due to the purification of hBN, characterized by strong absorption at 1363 cm⁻¹ and 811 cm⁻¹. In general, the improved purity of a BNNT mixture is characterized by decreased FWHMs of the corresponding absorption peaks. The f3-f5 obtained in the present disclosure showed a very distinct decrease in the FWHM of synthesized BNNT corresponding to 200-300 cm⁻′ to about 47 cm⁻¹. The FWHM was calculated by Lorentzian fitting. The FWHM of 47 cm⁻¹ reported in the present disclosure is a very small value when considering previously known various methods for purifying BNNT, supporting the improvement of BNNT purity by the present disclosure. In contrast, the strong absorption at 3200 cm⁻¹ and 1200 cm⁻¹ observed for the synthesized BNNT is due to the presence of B₂O₃. The peaks were decreased effectively in f3-f5. As a result of purity calculation by Lorentzian fitting, this corresponds to the B₂O₃ purification efficiency of 99% or higher.

### Detailed Description of Main Elements

| | |
|---|---|
| 110: column chromatography | 120: mobile phase inputting |
| device | device |
| 130: eluent supplying device | 140: UV detecting device |

What is claimed is:

1. Purified BNNT purified from synthesized BNNT by a column chromatography device, characterized by one or more of the following:
the purified BNNT has a full width at half maximum (FWHM) of an absorption peak in a range of 1300-1400 cm⁻¹ in the FTIR spectrum of 47 cm⁻¹ or smaller;
the purified BNNT has an FWHM of an absorption peak in a range of 1350-1400 cm⁻¹ in the Raman spectrum of 23 cm⁻¹±1 cm⁻¹;
the purified BNNT has an absorption peak area in a range of 850-900 cm⁻¹ in the Raman spectrum decreased by 99% or more as compared to the synthesized BNNT; and
the purified BNNT has a peak area at 2θ=28.0°±0.5° and a peak area at 2θ=26.7°±0.5° in the XRD spectrum decreased by 99% or more respectively as compared to the synthesized BNNT.

2. The purified BNNT according to claim 1, wherein the FWHM of the absorption peak, the absorption peak area or the XRD peak area is calculated using a Lorentzian fitting function.

3. The purified BNNT according to claim 1, wherein the absorption peak in a range of 1300-1400 cm⁻¹ in the FTIR spectrum corresponds to the absorption peak of BNNT.

4. The purified BNNT according to claim 1, wherein the absorption peak in a range of 1350-1400 cm⁻¹ in the Raman spectrum corresponds to the absorption peak of BNNT or hBN.

5. The purified BNNT according to claim 1, wherein the absorption peak area in a range of 850-900 cm⁻¹ in the Raman spectrum corresponds to the absorption peak of B₂O₃.

6. The purified BNNT according to claim 1, wherein the peak at 2θ=28.0°±0.5° corresponds to the peak of B₂O₃ and the peak at 2θ=26.7°±0.5° corresponds to the peak of hBN.

7. A method for purifying BNNT, wherein pure BNNT is separated from synthesized BNNT and is separated based on length by inputting a mobile phase comprising the synthesized BNNT into a column chromatography device.

8. The method for purifying BNNT according to claim 7, wherein the synthesized BNNT is a mixture of BNNT and impurities, the pure BNNT passes through a column faster as it has a longer length, and the BNNT with a relatively longer length is located at a lower portion of the column and the BNNT with a relatively shorter length is located at an upper portion of the column at a specific point of time.

9. The method for purifying BNNT according to claim 7, wherein the mobile phase is an aqueous solution in which synthesized BNNT and a surfactant are mixed.

10. The method for purifying BNNT according to claim 9, wherein the surfactant is a bile salt-based surfactant.

11. The method for purifying BNNT according to claim 10, wherein the bile salt-based surfactant is sodium cholate (SC) or sodium deoxycholate (DOC).

12. The method for purifying BNNT according to claim 7, wherein the column chromatography device is an apparatus wherein a porous stationary phase is filled in a column, and the porous stationary phase is any of a polymer gel bead, a polymer and an inorganic porous material having pores with a size of 1-80 kDa.

13. The method for purifying BNNT according to claim 7, wherein an eluent is injected into a column for transportation of the synthesized BNNT after the mobile phase has been inputted, and the eluent is an aqueous solution wherein a bile salt-based surfactant is mixed.

14. The method for purifying BNNT according to claim 7, wherein the BNNT with a relatively longer length and the BNNT with a relatively shorter length are discharged sequentially through a lower portion of a column and the impurities included in the synthesized BNNT are discharged before or after the discharge of the BNNT, and it is determined based on the presence of a UV absorption region in a UV chromatogram of the material discharged through the lower portion of the column whether the material is BNNT.

15. The method for purifying BNNT according to claim 14, wherein the material is BNNT if a UV absorption region is present in the UV chromatogram.

16. The method for purifying BNNT according to claim 7, wherein the mobile phase is prepared by:
a process of preparing an aqueous solution wherein a bile salt-based surfactant is mixed,
a process of mixing synthesized BNNT in the aqueous solution,
a process of uniformly dispersing the synthesized BNNT in the aqueous solution by irradiating ultrasound to the aqueous solution, and
a process of extracting a supernatant of the aqueous solution.

17. An apparatus for purifying BNNT, comprising:
a column chromatography device wherein a porous stationary phase is filled in a column;
a mobile phase inputting device which inputs a mobile phase comprising synthesized BNNT to an upper portion of the column; and
an eluent supplying device which supplies an eluent to the column to facilitate the transportation of the mobile phase after the mobile phase is inputted,
wherein the synthesized BNNT is a mixture of BNNT and impurities, the pure BNNT passes through a column faster as it has a longer length, and the BNNT with a relatively longer length is located at a lower portion of the column and the BNNT with a relatively shorter length is located at an upper portion of the column at a specific point of time.

18. The apparatus for purifying BNNT according to claim 17, which further comprises a UV detecting device which generates a UV chromatogram by irradiating UV to a material that has been discharged through the lower portion of the column, wherein it is determined based on the presence of a UV absorption region in the UV chromatogram whether the material is BNNT.

19. The apparatus for purifying BNNT according to claim 18, wherein the material is BNNT if a UV absorption region is present in the UV chromatogram.

20. The apparatus for purifying BNNT according to claim 17, wherein the mobile phase is an aqueous solution in which synthesized BNNT and a bile salt-based surfactant are mixed, the bile salt-based surfactant is sodium cholate (SC) or sodium deoxycholate (DOC), and the porous stationary phase is a polymer gel bead or a glass fiber having pores with a size of 1-80 kDa.
